(19) United States
(12) Patent Application Publication
(10) Pub. No.: US 2005/0091053 A1
(43) Pub. Date: Apr. 28, 2005

(54) Voice recognition system

(75) Inventors: Hajime Kobayashi, Saitama (JP); Mitsuya Komamura, Saitama (JP); Soichi Toyama, Saitama (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/995,509

(22) Filed: Nov. 24, 2004

Related U.S. Application Data
(63) Continuation of application No. 09/948,762, filed on Sep. 10, 2001.

(30) Foreign Application Priority Data
Sep. 12, 2000 (JP) P. 2000-277024

(51) Int. Cl. G10L 11/04

(52) U.S. Cl. 704/250

(57) ABSTRACT

A trained vector creating part 15 creates a characteristic of an unvoiced sound in advance as a trained vector V. Meanwhile, a threshold value THD for distinguishing a voice from a background sound is created based on a predictive residual power ε of a sound which is created during a non-voice period. As a voice is actually uttered, an inner product computation part 18 calculates an inner product of a feature vector A of an input signal Sa and a trained vector V, and a first threshold value judging part 19 judges that it is a voice section when the inner product has a value which is equal to or larger than a predetermined value θ while a second threshold value judging part 21 judges that it is a voice section when the predictive residual power ε of the input signal Sa is larger than a threshold value THD. As at least one of the first threshold value judging part 19 and the second threshold value judging part 21 judges that it is a voice section, a voice section determining part 300 finally judges that it is a voice section and cuts out an input signal Saf which are in units of frames and corresponds to this voice section as a voice Svc which is to be recognized.

### BACKGROUND OF THE INVENTION

1. Field of the Invention

The present invention relates to a voice recognition system, and more particularly, to a voice recognition system which has an improved accuracy of detecting a voice section.

2. Description of the Related Art

When a voice uttered in an environment in which noises or the like exist, for instance, is recognized as it is, a voice recognition rate deteriorates due to an influence of the noises, etc. Hence, an essential issue of a voice recognition system for the purpose of voice recognition is to correctly detect a voice section.

A voice recognition system which uses a residual power method or a subspace method for detection of a voice section is well known.

FIG. 6 shows a structure of a conventional voice recognition system which uses a residual power method. In this voice recognition system, acoustic models (voice HMMs) which are in units of words or sub-words (e.g., phonemes, syllables) are prepared using Hidden Markov Models (HMMs), and when a voice to recognize is uttered, an observed value series is created which is a time series of the spectrum of the input signal, the observed value series is checked against the voice HMMs, and the voice HMM which has the largest likelihood is selected and outputted as a result of the recognition.

More specifically, a large quantity of voice data Sm collected and stored in a voice database are partitioned into frames each lasting for a predetermined period of time (approximately 10-20 msec), and the data partitioned in the unit of frames are each sequentially subjected to cepstrum computation, whereby a cepstrum time series is calculated. The cepstrum time series is then processed through training processing as characteristic quantities representing voices and reflected in parameters for the acoustic models (voice HMMs), so that voice HMMs which are in the unit of words or sub-words are created.

When a voice is actually uttered, input voice data Sa are inputted as they are partitioned in units of frames in a manner similar to the above. A voice section detecting part which is constructed using a residual power method detects a voice section τ based on each piece of the input signal data which are in units of frames, input voice data Svc which are within the detected voice section τ is cut out, an observed value series which is a cepstrum time series of the input voice data Svc is compared with the voice HMMs in units of words or sub-words, whereby voice recognition is realized.

The voice section detecting part comprises an LPC analysis part 1, a threshold value creating part 2, a comparison part 3, switchover parts 4 and 5.

The LPC analysis part 1 executes linear predictive coding (LPC) analysis on the input signal data Sa which are in units of frames to thereby calculate a predictive residual power ε. The switchover part 4 supplies the predictive residual power ε to the threshold value creating part 2 during a predetermined period of time (non-voice period) until a speaker actually starts speaking since turning on of a speak start switch (not shown) by the speaker, for instance, but after the non-voice period ends, the switchover part 4 supplies the predictive residual power ε to the comparison part 3.

The threshold value creating part 2 calculates an average ε′ of the predictive residual power ε which is created during the non-voice period, adds a predetermined value α which is determined in advance to this, accordingly calculates a threshold value THD (=ε′+α), and supplies the threshold value THD to the comparison part 3.

The comparison part 3 compares the threshold value THD with the predictive residual power ε which is supplied through the switchover part 4 after the non-voice period ends, and turns on the switchover part 5 (makes the switchover part 5 conducting) when judging that THD≦ε holds and therefore it is a voice section, but turns off (makes the switchover part 5 not conducting) when judging that THD>ε holds and therefore it is a non-voice section.

The switchover part 5 performs the on/off operation described above under the control of the comparison part 3. Accordingly, during a period which is determined as a voice section, the input voice data Svc which are to be recognized are cut out in the unit of frames from the input signal data Sa, the cepstrum computation described above is carried out based on the input voice data Svc, and an observed value series to be checked against the voice HMMs is created.

In this manner, in a conventional voice recognition system which detects a voice section using a residual power method, the threshold value THD for detecting a voice section is determined based on the average ε′ of the predictive residual power ε which is created during a non-voice period, and whether the predictive residual power ε′ of the input signal data Sa which are inputted after the non-voice period is a larger value than the threshold value THD or not is judged, whereby a voice section is detected.

FIG. 7 shows a structure of a voice section detecting part which uses a subspace method. This voice section detecting part projects a feature vector of an input signal upon a space (subspace) which denotes characteristics of voices trained in advance from a large quantity of voice data, and identifies a voice section when a projection quantity becomes large.

In other words, voice data Sm for training (training data) collected in advance are acoustically analyzed in the unit of predetermined frames, thereby calculating an M-dimensional feature vector Xₙ=[Xₙ₁Xₙ₂Xₙ₃ . . . X_{nM}]^{T}. The variable M denotes a dimension number of the vector, the variable n denotes a frame number (n≦N), and the symbol T denotes transposition.

From this M-dimensional feature vector Xₙ, a correlation matrix R which is expressed by the following formula (1) is yielded. Further, the formula (2) below is solved to thereby eigenvalue-expand the correlation matrix R, thereby calculating an M pieces of eigenvalues λₖ and eigenvectors Vₖ.

$$\begin{matrix}R = \frac{1}{N} {\sum }_{n = 1}^{N} {X}_{n} {X}_{n}^{T} & ( 1 ) \\ ( R - {λ}_{k} I ) {v}_{k} = 0 & ( 2 )\end{matrix}$$

where
k=1, 2, 3, . . . , M;
I denotes a unit matrix; and
0 denotes a zero vector.

Next, m pieces (m<M) of eigenvectors V₁, V₂, . . . , Vₘ having larger eigenvalues are selected, and a matrix V=[V₁, V₂, . . . , Vₘ] in which the selected eigenvectors are column vectors is established. In other words, a space defined by the m pieces of eigenvectors V₁, V₂, . . . , Vₘ is assumed to be a subspace which best expresses characteristics of a voice which is obtained through training.

Next, a projective matrix P is calculated from the formula (3) below.

$$P = {VV}^{T} = {\sum }_{k = 1}^{m} {V}_{k} {V}_{k}^{T} \qquad ( 3 )$$

The projective matrix P is established in advance in this manner. As the input signal data Sa are inputted, in a manner similar to that for processing the training data Sm, the input signal data Sa are acoustically analyzed in units of predetermined frames, whereby a feature vector a of the input signal data Sa is calculated. A product of the projective matrix P and the feature vector a is thereafter calculated, so that a square norm ∥Pa∥² of a projective vector Pa which is expressed by the formula (4) below is calculated.
∥Pa∥² (Pa)^{T}Pa=a^{T}P^{T}Pa=a^{T}Pa (4)

In the formula, a power equality of the projective matrix P^{T}P=P is used.

A threshold value θ which is determined in advance is compared with the square norm above, and when θ<∥Pa∥² holds, it is judged that this is a voice section, the input signal data Sa within this voice section are cut out, and the voice is recognized based on the voice data Svc thus cut out.

However, the conventional detection above of a voice section using a residual power method has a problem wherein as an SN ratio becomes low, a difference in terms of predictive residual power between a noise and an original voice becomes small, and therefore, a detection accuracy of detecting a voice section becomes low. In particular, a problem exists where it becomes difficult to detect a part of a unvoiced sound whose power is small.

In addition, while the conventional method described above of detecting a voice section using a subspace method notes a difference between a spectrum of a voice (a voiced sound and an unvoiced sound) and a spectrum of a noise, since it is not possible to clearly distinguish these spectra from each other, there is a problem wherein a detection accuracy of detecting a voice section cannot be improved.

More specifically describing with reference to FIGS. 8A through 8C problems with a subspace method in a situation that a voice uttered inside an automobile is to be recognized, the problems are as follows. FIG. 8A shows an envelope of spectra expressing the typical voiced sounds of “a,” “i,” “u,” “e” and “o”, FIG. 8B shows an envelope of spectra expressing plurality types of typical unvoiced sounds, and FIG. 8C shows an envelope of spectra expressing running car noises which are developed inside a plurality of automobiles whose engine displacements are different from each other.

As these spectra envelopes show, a problem is that it is difficult to distinguish the voiced sounds and the running car noises from each other since the spectra of the voiced sounds and the running car noises are similar to each other.

Further, norms of feature vectors change due to vowel sounds, consonants, etc., and therefore, even when these vectors match the subspace, norms of the vectors as they are after being projected become small if the vectors as they are before being projected are small. Since a consonant, in particular, has a small norm of a feature vector, there is a problem that the consonant fails to be detected as a voice section.

Moreover, spectra expressing voiced sounds are large in a low frequency region, while spectra expressing unvoiced sounds are large in a high frequency region. Because of this, the conventional approaches in which voiced sounds and unvoiced sounds are trained altogether give rise to a problem that it is difficult to obtain an appropriate subspace.

### SUMMARY OF THE INVENTION

An object of the present invention is to provide a voice recognition system which solves the problems described above which are with the conventional techniques and improves a detection accuracy of detecting a voice section.

To achieve the object above, the present invention is directed to a voice recognition system which comprises a voice section detecting part which detects a part of a voice which is an object of voice recognition,
characterized in that the voice section detecting part comprises: a trained vector creating part which creates a characteristic of a voice as a trained vector in advance; and an inner product value judging part which calculates an inner product of a feature vector of an input signal containing utterance of a voice and the trained vector, and judges that a part at which the inner product value is equal to or larger than a predetermined value is a voice section; and the input voice during the voice section which is judged by the inner product value judging part is an object of voice recognition.

According to this structure, an inner product of a trained vector prepared in advance based on an unvoiced sound and a feature vector of an input signal which contains a voice is actually uttered is calculated, and a point at which the calculated inner product value is larger than the predetermined threshold value is judged as a part of an unvoiced sound. A voice section of the input signal is set based on the result of the judgment, whereby the voice which is to be recognized is properly found.

Further, to achieve the object above, the present invention is directed to a voice recognition system which comprises a voice section detecting part which detects a part of a voice which is an object of voice recognition, characterized in that the voice section detecting part comprises: a trained vector creating part which creates a characteristic of a voice as a trained vector in advance; a threshold value creating part which creates a threshold value for distinguishing a voice from a noise based on a linear predictive residual power of an input signal which is created during a non-voice period; an inner product value judging part which calculates an inner product of a feature vector of an input signal which contains utterance of a voice and the trained vector, and judges that a point at which the inner product value is equal to or larger than a predetermined value is a voice section; and a linear predictive residual power judging part which judges that a point at which a linear predictive residual power of the input signal containing utterance of the voice is larger than the threshold value which is created by the threshold value creating part is a voice section, and the input signal during the voice section which is judged by the inner product value judging part and the linear predictive residual power judging part is an object of voice recognition.

According to this structure, an inner product of a trained vector prepared in advance based on an unvoiced sound and a feature vector of an input signal which contains a voice actually uttered is calculated, and a point at which the calculated inner product value is larger than the predetermined threshold value is judged as a unvoiced sound part. In addition, the threshold value calculated based on a predictive residual power during a non-voice period is compared with a predictive residual power of the input signal which contains the actual utterance of the voice, and a point at which this predictive residual power is larger than the threshold value is judged as a part of a voiced sound. A voice section of the input signal is set based on the results of the judgments, whereby the voice which is to be recognized is properly found.

Further, to achieve the object above, the present invention is characterized in comprising an incorrect judgment controlling part which calculates an inner product of a feature vector of the input signal created during the non-voice period and the trained vector and stops judging processing by the inner product value judging part when the inner product value is equal to or larger than a predetermined value.

According to this structure, an inner product of a trained vector and a feature vector which is obtained during a non-voice period before actual utterance of a voice, that is, during a period in which only a background sound exists is calculated, and the judging processing by the inner product value judging part is stopped when the inner product value is equal to or larger than the predetermined value. This allows to avoid an incorrect detection of a background sound as a consonant, in a background that an SN ratio is high and a spectrum of the background sound is accordingly high in a high frequency region.

Further, to achieve the object above, the present invention is characterized in comprising a computing part which calculates a linear predictive residual power of the input signal containing utterance of a voice; and an incorrect judgment controlling part which stops judging processing by the inner product value judging part when the linear predictive residual power calculated by the a computing part is equal to or smaller than a predetermined value.

According to this structure, when a predictive residual power obtained during a non-voice period before actual utterance of a voice, that is, during a period in which only a background sound exists is equal to or smaller than the predetermined value, the judging processing by the linear predictive residual power judging part is stopped. This allows to avoid an incorrect detection of a background sound as a consonant, in a background that an SN ratio is high and a spectrum of the background sound is accordingly high in a high frequency region.

Further, to achieve the object above, the present invention is characterized in comprising a computing part which calculates a linear predictive residual power of the input signal containing utterance of a voice; and an incorrect judgment controlling part which calculates an inner product of a feature vector of the input signal which is created during the non-voice period and the trained vector and stops judging processing by the inner product value judging part when the inner product value is equal to or larger than a predetermined value or when a linear predictive residual power of the input signal which is created during the non-voice period is equal to or smaller than a predetermined value.

According to this structure, when an inner product of the trained vector and a feature vector which is obtained during a non-voice period before actual utterance of a voice, that is, during a period in which only a background sound exists is equal to or larger than the predetermined value or when a predictive residual power of the input signal which is created during the non-voice period is equal to or smaller than the predetermined value, the judging processing by the inner product value judging part is stopped. This allows to avoid an incorrect detection of a background sound as a consonant, in a background that an SN ratio is high and a spectrum of the background sound is accordingly high in a high frequency region.

### BRIEF DESCRIPTION OF THE DRAWINGS

FIG. 1 is a block diagram showing a structure of the voice recognition system according to a first embodiment.

FIG. 2 is a block diagram showing a structure of the voice recognition system according to a second embodiment.

FIG. 3 is a block diagram showing a structure of the voice recognition system according to a third embodiment.

FIG. 4 is a block diagram showing a structure of the voice recognition system according to a fourth embodiment.

FIG. 5 is a characteristics diagram showing an envelope of spectra which are obtained from trained vectors representing unvoiced sound data.

FIG. 6 is a block diagram showing a structure of the voice section detecting part which uses a conventional residual power method.

FIG. 7 is a block diagram showing a structure of the voice section detecting part which uses a conventional sub space method.

Each of FIGS. 8A to 8C is a characteristics diagram showing an envelope of spectra of a voice and a running car noise.

### DETAILED DESCRIPTION OF THE PRESENT INVENTION

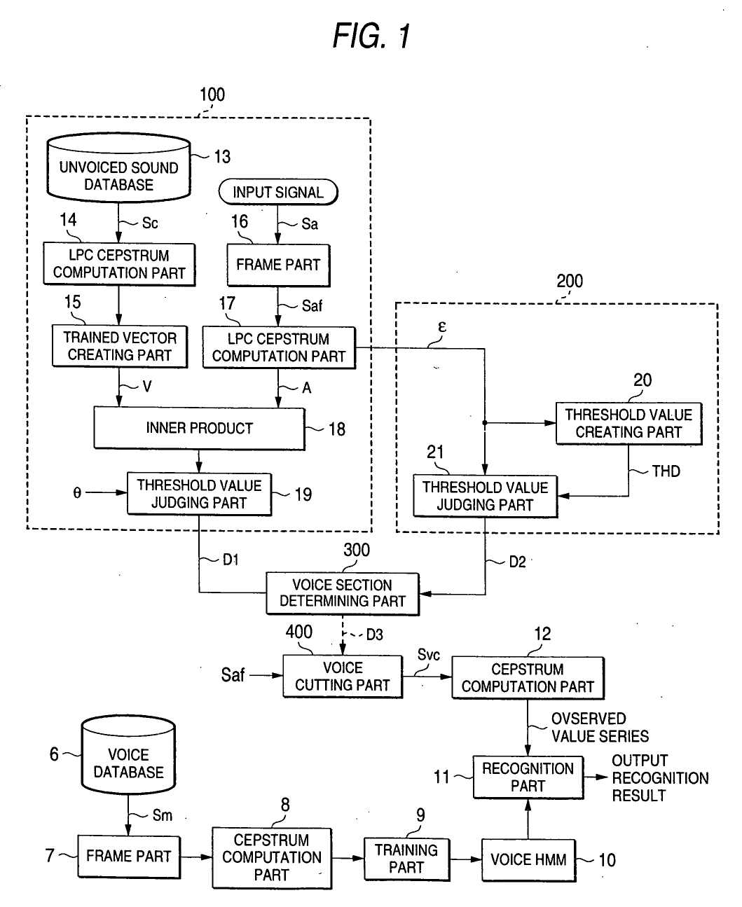

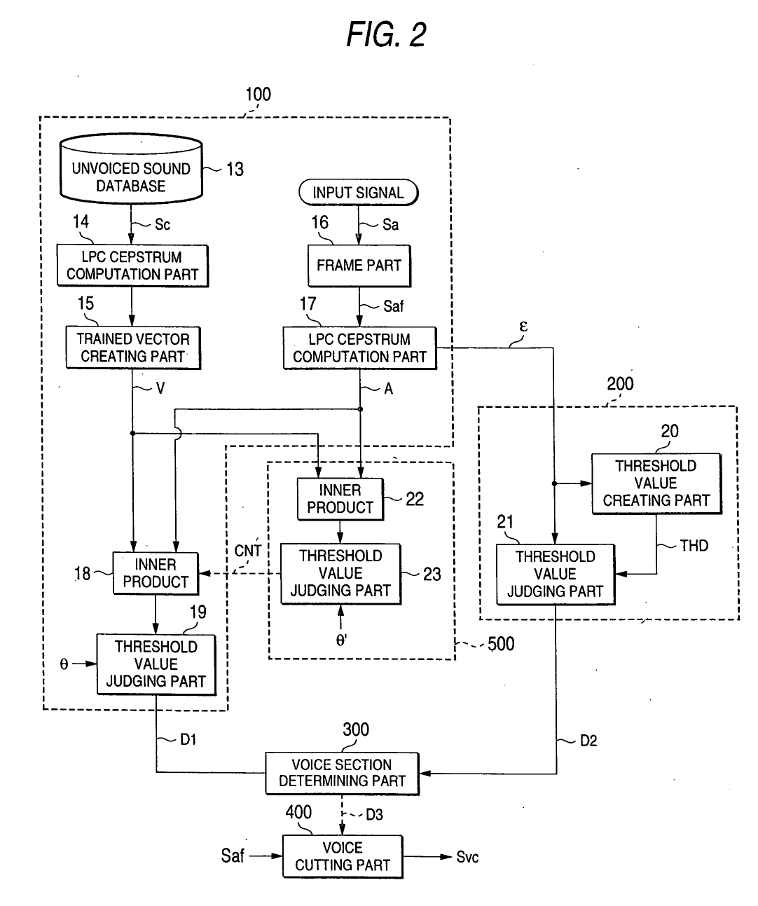

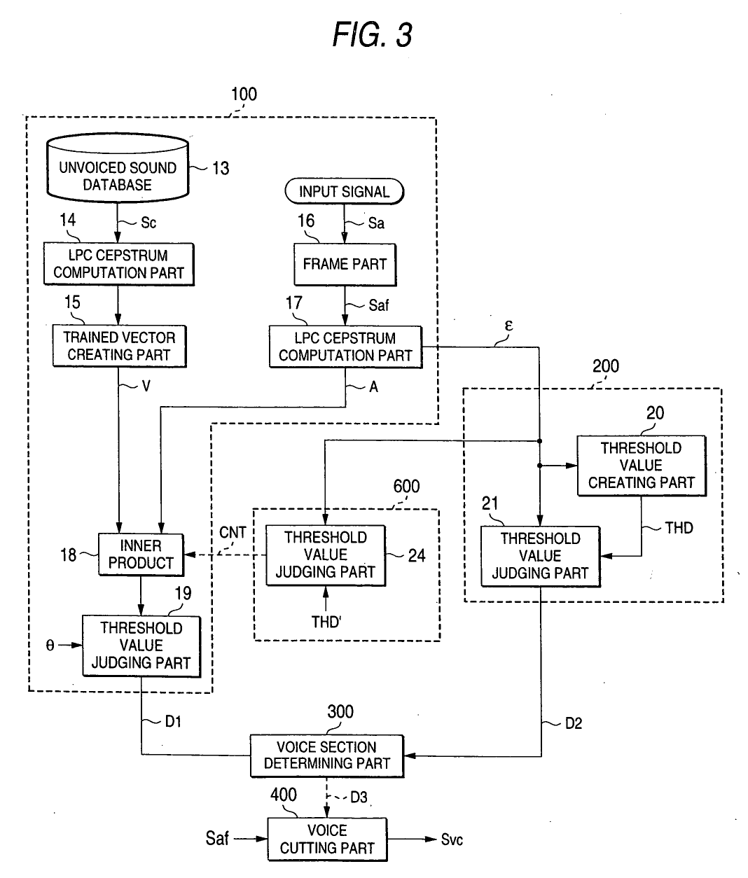

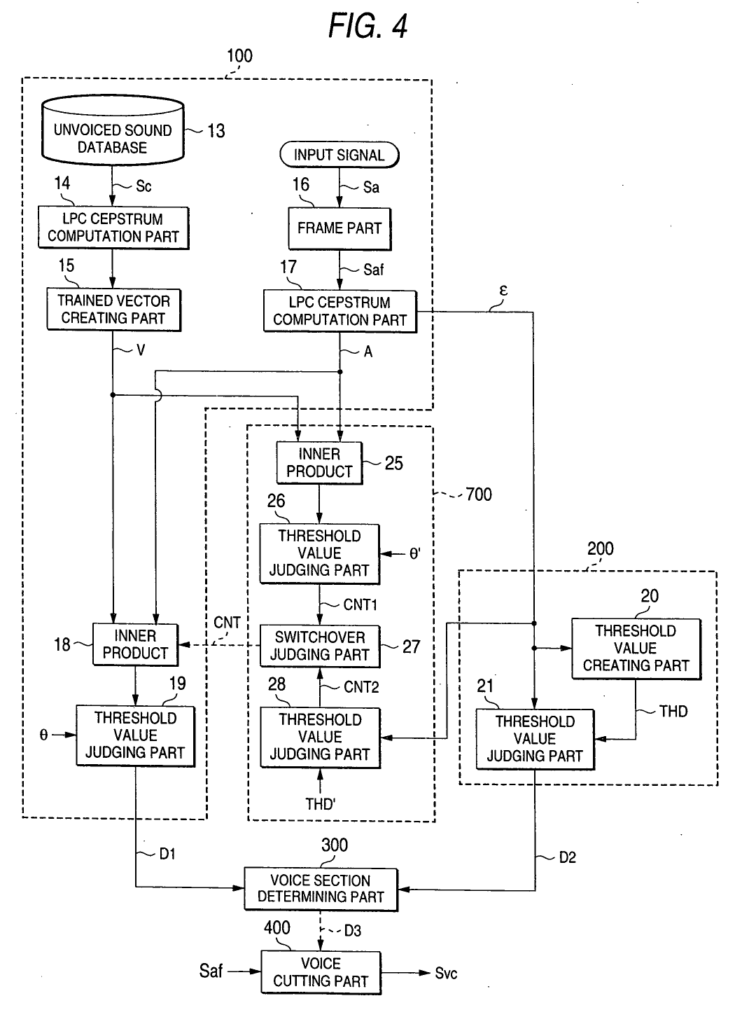

In the following, preferred embodiments of the present invention will be described with reference to the drawings. FIG. 1 is a block diagram which shows a structure in a first preferred embodiment of a voice recognition system according to the present invention, FIG. 2 is a block diagram which shows a structure according to a second preferred embodiment, FIG. 3 is a block diagram which shows a structure according to a third preferred embodiment, and FIG. 4 is a block diagram which shows a structure according to a fourth preferred embodiment.

### First Embodiment

This embodiment is typically directed to a voice recognition system which recognizes a voice by means of an HMM method and comprises a part which cuts out a voice for the purpose of voice recognition.

In FIG. 1, the voice recognition system of the first preferred embodiment comprises acoustic models (voice HMMs) 10 which are created in units of words or sub-words using a Hidden Markov Model, a recognition part 11, and a cepstrum computation part 12. The recognition part 11 checks an observed value series, which is a cepstrum time series of an input voice which is created by the cepstrum computation part 12, against the voice HMMs 10, selects the voice HMM which bears the largest likelihood and outputs this as a recognition result.

In other words, a frame part 7 partitions voice data Sm which have been collected and stored in a voice database 6 into predetermined frames, and a cepstrum computation part 8 sequentially computes cepstrum of the voice data which are now in units of frames to thereby obtain a cepstrum time series. A training part 9 then processes the cepstrum time series by training processing as a characteristic quantity, whereby the voice HMMs 10 in units of words or sub-words are created in advance.

The cepstrum computation part 12 computes cepstrum of the actual input voice data Svc which will be cut out in response to detection of a voice section which will be described later, so that the observed value series mentioned above is created. The recognizing part 11 checks the observed value series against the voice HMMs 10 in the unit of words or sub-words and voice recognition is accordingly executed.

Further, the voice recognition system comprises a voice section detecting part which detects a voice section of the actually uttered voice (input signal) Sa and cuts out the input voice data Svc above which are an object of voice recognition. The voice section detecting part comprises a first detecting part 100, a second detecting part 200, a voice section determining part 300 and a voice cutting part 400.

The first detecting part 100 comprises an unvoiced sound database 13 which stores data (unvoiced sound data) Sc of unvoiced sound portions of voices which have been collected in advance, an LPC cepstrum computation part 14 and a trained vector creating part 15.

The LPC cepstrum computation part 14 LPC-analyzes in units of frames the unvoiced sound data Sc stored in the unvoiced sound database 13, to thereby calculate an M-dimensional feature vector Cₙ=[cₙ₁, cₙ₂, . . . c_{nM}]^{T} in a cepstrum region.

The trained vector creating part 15 calculates a correlation matrix R which is expressed by the following formula (5) from the M-dimensional feature vector cₙ and further eigenvalue-expands the correlation matrix R, whereby M pieces of eigenvalues λₖ and eigenvectors Vₖ are obtained and the eigenvector which corresponds to the largest eigenvalue among the M pieces of eigenvalues λₖ is set as a trained vector V. In the formula (5), the variable n denotes a frame number and the symbol T denotes transposition.

$$R = \frac{1}{N} {\sum }_{n = 1}^{N} {C}_{n} {C}_{n}^{T} \qquad ( 5 )$$

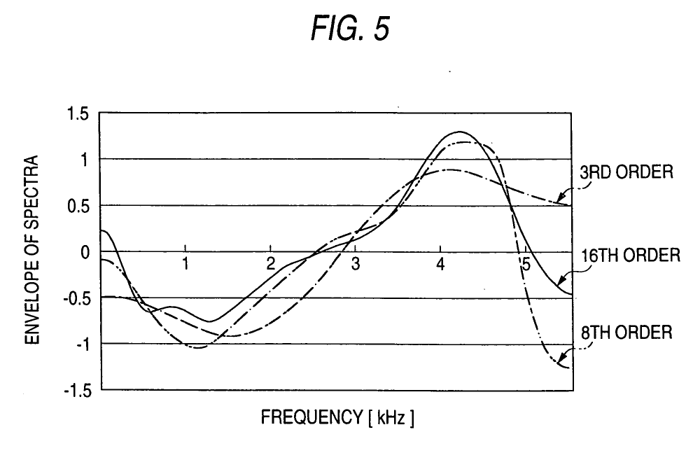

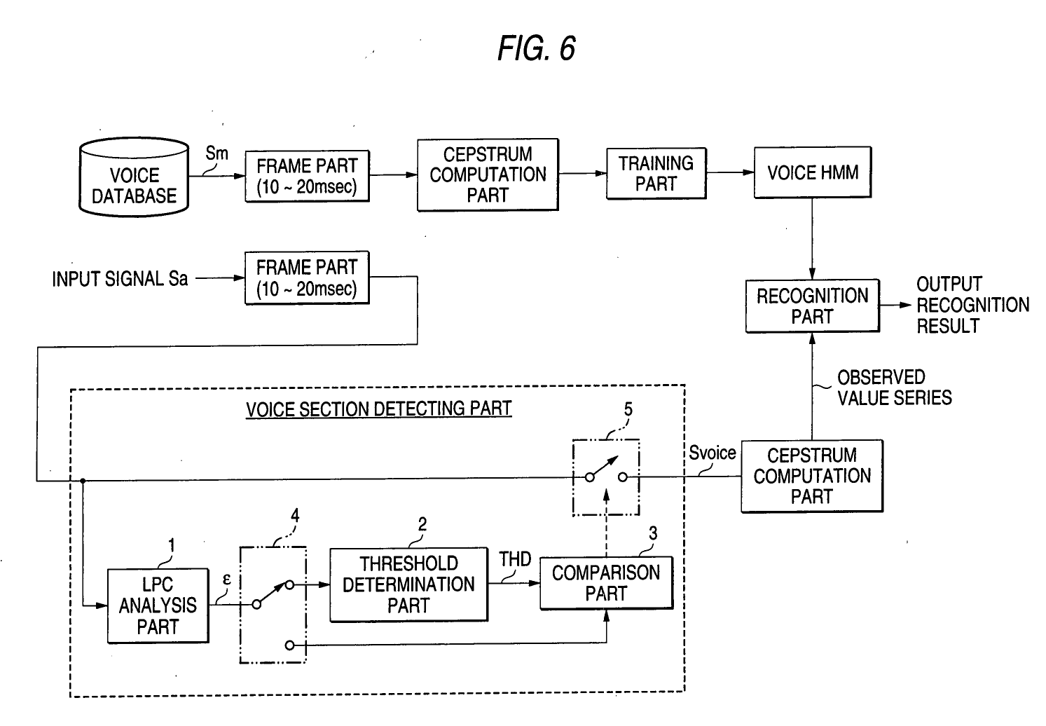

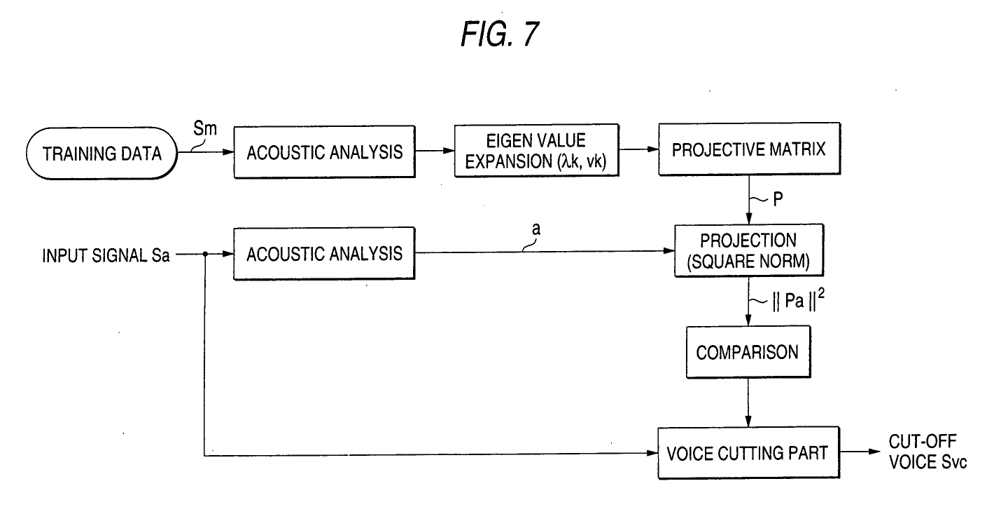

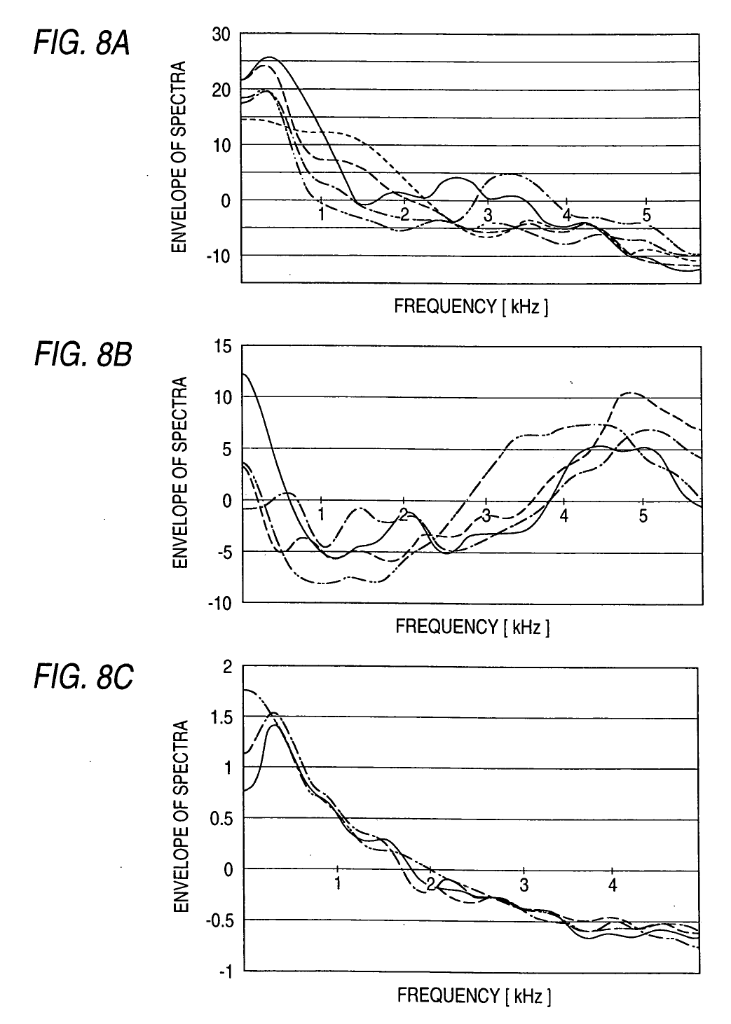

As a result of the processing by the LPC cepstrum computation part 14 and the trained vector creating part 15, the trained vector V which well represents a characteristic of an unvoiced sound is obtained. FIG. 5 shows an envelope of spectra which are obtained from the trained vector V. The orders are orders (3rd-order, 8th-order, 16th-order) for LPC analysis. Since the envelope of the spectra which are shown in FIG. 5, are extremely similar to envelope of spectra which express an actual unvoiced sound which are shown in FIG. 8B, it is confirmed that the trained vector V which well represents a characteristic of an unvoiced sound is obtainable.

Further, the first detecting part 100 comprises a frame part 16 which partitions the input signal data Sa into frames in a similar manner to the above, an LPC cepstrum computation part 17 which calculates an M-dimensional feature vector A in a cepstrum region and a predictive residual power ε by executing LPC analysis on input signal data Saf which are in the unit of frames, an inner product computation part 18 which calculates an inner product V^{T}A of the trained vector V and the feature vector A, and a first threshold value judging part 19 which compares the inner product V^{T}A with a predetermined threshold value θ and judges that it is a voice section if θ≦V^{T}A. Thus, a judgment result D1 yielded by the first threshold value judging part 19 is supplied to the voice section determining part 300.

The inner product V^{T}A is a scalar quantity which holds direction information regarding the trained vector V and the feature vector A, that is, a scalar quantity which has either a positive value or a negative value. The scalar quantity has a positive value when the feature vector A is in the same direction as that of the feature vector V (0≦V^{T}A) but a negative value when the trained vector A is in the opposite direction to that of the trained vector V (0>V^{T}A). Because of this, θ=0 in this embodiment.

The second detecting part 200 comprises a threshold value creating part 20 and a second threshold value judging part 21.

During a predetermined period of time (non-voice period) since a speaker turns on a speak start switch (not shown) of the voice recognition system until the speaker actually starts speaking, the threshold value creating part 20 calculates an average ε′ of the predictive residual power e which is calculated by the LPC cepstrum computation part 17 and then adds the average ε′ to a predetermined value ε to thereby obtain a threshold value THD (=ε′+α).

After the non-voice period elapses, the second threshold value judging part 21 compares the predictive residual power ε which is calculated by the LPC cepstrum computation part 17 with the threshold value THD. When THD≦ε e holds, the second threshold value judging part 21 judges that it is a voice section and supplies this judgment result D2 to the voice section determining part 300.

A point at which the judgment result D1 is supplied from the first detecting part 100 and a point at which the judgment result D2 is supplied from the second detecting part 200 is determined by the voice section determining part 300 as a voice section τ of the input signal Sa. In short, the voice section determining part 300 determines a point at which either condition θ≦V^{T}A or THD≦ε is satisfied as the voice section τ, changes a short voice section which is between non-voice sections to a non-voice section, changes a short non-voice section which is between voice sections to a voice section, and supplies this decision D3 to the voice cutting part 400.

Based on the decision D3 above, the voice cutting part 400 cuts out input voice data Svc which are to be recognized from input signal data Saf which are in the unit of frames and supplied from the frame part 16, and supplies the input voice data Svc to the cepstrum computation part 12.

The cepstrum computation part 12 creates an observed value series in a cepstrum region from the input voice data Svc which are cut out in units of frames, and the recognizing part 11 checks the observed value series against the voice HMMs 10, whereby voice recognition is accordingly realized.

In this manner, in the voice recognition system according to this embodiment, the first detecting part 100 correctly detects a voice section of an unvoiced sound and the second detecting part 200 correctly detects a voice section of a voiced sound.

More precisely, the first detecting part 100 calculates an inner product of the trained vector V of an unvoiced sound which is created in advance based on the unvoiced sound training data Sc and a feature vector of the input signal data Sa which contains a voice actually uttered, and judges that a point at which the obtained inner product has a larger value than the threshold θ=0 (i.e., a positive value) is an unvoiced sound part in the input signal data Sa. The second detecting part 200 compares the threshold value THD, which is calculated in advance based on a predictive residual power of a non-voice period, with the predictive residual power ε of the input signal data Sa containing the actual utterance of the voice, and judges that a point at which THD≦ε is satisfied is a voiced sound part in the input signal data Sa.

In other words, the processing by the first detecting part 100 makes it possible to detect an unvoiced sound whose power is relatively small at a high accuracy, and the processing by the second detecting part 200 makes it possible to detect a voiced sound whose power is relatively large at a high accuracy.

The voice section determining part finally determines a voice section (which is a part of a voiced sound or an unvoiced sound) based on the judgment results D1 and D2 which are made by the first and the second detecting parts' 100 and 200, and input voice data Svc which are to be recognized is cut out in accordance with this decision D3. Hence, it is possible to enhance the accuracy of voice recognition.

In the structure according to this embodiment shown in FIG. 1, based on the judgment result D1 made by the first threshold value judging part 19 and the judgment result D2 made by the second threshold value judging part 21, the voice section determining part 300 outputs the decision D3 which is indicative of a voice section.

However, the present invention is not limited only to this. The structure may omit the second detecting part 200 while in the meantime comprising the first detecting part 100 in which the inner product part 18 and the threshold value judging part 19 judge a voice section, so that the voice section determining part 300 outputs the decision D3 which is indicative of a voice section based on the judgment result D1.

### Second Embodiment

Next, a voice recognition system according to a second preferred embodiment will be described with reference to FIG. 2. In FIG. 2, the portions which are the same as or correspond to those in FIG. 1 are denoted at the same reference symbols.

A difference of FIG. 2 from the first preferred embodiment is that the voice recognition system according to the second preferred embodiment comprises an incorrect judgment controlling part 500 which comprises an inner product computation part 22 and a third threshold value judging part 23.

During a non-voice period until the speaker actually starts speaking since a speaker turns on a speak start switch (not shown) of the voice recognition system, the inner product computation part 22 calculates an inner product of the feature vector A which is calculated by the LPC cepstrum computation part 17 and the trained vector V of an unvoiced sound calculated in advance by the trained vector creating part 15. That is, during the non-voice period before the actual utterance of the voice, the inner product computation part 22 calculates the inner product V^{T}A of the trained vector V and the feature vector A.

The third threshold value judging part 23 compares a threshold value θ′ (=0) which is determined in advance with the inner product V^{T}A which is calculated by the inner product computation part 22, and when θ′<V^{T}A is satisfied even regarding only one frame, provides the inner product computation part 18 with a control signal CNT which is for stopping calculation of an inner product. In other words, if the inner product V^{T}A of the trained vector V and the feature vector A calculated during the non-voice period is a larger value (positive value) than the threshold value θ′, even when a speaker actually utters a voice after the non-voice period elapses, the third threshold value judging part 23 prohibits the inner product computation part 18 from the processing of calculating an inner product.

As the inner product computation part 18 accordingly stops the processing of calculating an inner product in response to the control signal CNT, the first threshold value judging part 19 as well substantially stops the processing of detecting a voice section, and therefore, the judgment result D1 is not supplied to the voice section determining part 300. That is, the voice section determining part 300 finally judges a voice section based on the judgment result D2 which is supplied from the second detecting part 200.

This embodiment which is directed to such a structure creates the following effect. On the premise that spectra representing unvoiced sounds become high in a high frequency region and spectra representing background noises become high in a low frequency region, the first detecting part 100 detects a voice section. Hence, even where the first detecting part 100 alone performs the processing of calculating an inner product without using the incorrect judgment controlling part 500 described above, in a background that an SN ratio is low and running car noises are dominant as in an automobile, for instance, the accuracy of detecting a voice section improves.

However, in a background that an SN ratio is high and spectra representing background noises are accordingly high in a high frequency region, with the processing by only the inner product computation part 18, there is a problem that a possibility of incorrect judgement of a noise part as a voice section is high.

In contrast, in the incorrect judgment controlling part 500, the inner product computation part 22 calculates the inner product V^{T}A of the trained vector V of an unvoiced sound and the feature vector A which is obtained only during a non-voice period before actual utterance of a voice, that is, during a period in which only background noises exist, and the third threshold value judging part 23 checks if the relationship θ′<V^{T}A holds and accordingly judges whether spectra representing background noises are high in a high frequency region. When it is judged that the spectra representing the background noises are high in the high frequency region, the processing by the first inner product computation part 18 is stopped.

Hence, this embodiment which uses the incorrect judgment controlling part 500 creates an effect that in a background wherein an SN ratio is high and spectra representing background noises are accordingly high in a high frequency region, a situation leading to a detection error (incorrect detection) regarding consonants is avoided. This makes it possible to detect a voice section in such a manner which improves a voice recognition rate.

In the structure according to this embodiment which is shown in FIG. 2, the voice section determining part 300 outputs the decision D3 which is indicative of a voice section based on the judgment result D1 made by the threshold value judging part 19 and the judgment result D2 made by the threshold value judging part 21.

The present invention, however, is not limited only to this. The second detecting part 200 may be omitted, so that the voice section determining part 300 outputs the decision D3 which is indicative of a voice section based on the judgment result D1 made by the first detecting part 100 and the incorrect judgment controlling part 500.

### Third Embodiment

Next, a voice recognition system according to a third preferred embodiment will be described with reference to FIG. 3. In FIG. 3, the portions which are the same as or correspond to those in FIG. 2 are denoted at the same reference symbols.

A difference between the embodiment shown in FIG. 3 and the second embodiment shown in FIG. 2 is that in the voice recognition system according to the second preferred embodiment, as shown in FIG. 2, the inner product V^{T}A of the trained vector V and the feature vector A, which is calculated by the LPC cepstrum computation part 17 during a non-voice period before actual utterance of a voice, is calculated and the processing by the inner product computation part 18 is stopped when the calculated inner product satisfies ε′<V^{T}A, whereby an incorrect judgment of a voice section is avoided.

In contrast, as shown in FIG. 3, the third preferred embodiment is directed to a structure in which an incorrect judgment controlling part 600 is provided and a third threshold value judging part 24 within the incorrect judgment controlling part 600 executes judging processing for avoiding an incorrect judgment of a voice section based on the predictive residual power ε which is calculated by the LPC cepstrum computation part 17 during a non-voice period before actual utterance of a voice and the inner product computation part 18 is controlled based on the control signal CNT.

That is, as the LPC cepstrum computation part 17 calculates the predictive residual power ε of the background sound during a non-voice period until a speaker actually starts speaking since the speaker turns on a speak start switch (not shown), the third threshold value judging part 24 calculates the average ε′ of the predictive residual power ε, compares the average ε with a threshold value THD′ which is determined in advance, and if ε′<THD′ holds, provides the inner product computation part 18 with the control signal CNT which stops calculation of an inner product. In other words, when ε′<THD′ holds, even if a speaker actually utters a voice after the non-voice period elapses, the third threshold value judging part 24 prohibits the inner product computation part 18 from the processing of calculating an inner product.

A predictive residual power εₒ which is obtained in a relatively quiet environment is used as a reference (0 dB), and a value which is 0 dB through 50 dB higher than this is set as the threshold value THD′ mentioned above.

The third preferred embodiment as well which is directed in such a structure, as in the case of the second preferred embodiment described above, allows to maintain a detection accuracy of detecting a voice section even in a background that an SN ratio is high and spectra representing background noises are accordingly high in a high frequency region, and hence, to detect a voice section in such a manner which improves a voice recognition rate.

In the structure according to this embodiment which is shown in FIG. 3, the voice section determining part 300 outputs the decision D3 which is indicative of a voice section based on the judgment result D1 made by the threshold value judging part 19 and the judgment result D2 made by the threshold value judging part 21.

The present invention, however, is not limited only to this. The second detecting part 200 may be omitted, so that the voice section determining part 300 outputs the decision D3 which is indicative of a voice section based on the judgment result D1 made by the first detecting part 100 and the incorrect judgment controlling part 600.

### Fourth Embodiment

Next, a voice recognition system according to a fourth preferred embodiment will be described with reference to FIG. 4. In FIG. 4, the portions which are the same as or correspond to those in FIG. 2 are denoted at the same reference symbols.

The embodiment shown in FIG. 4 uses an incorrect judgment controlling part 700 which has a function as the incorrect judgment controlling part 500 which has been described in relation to the second preferred embodiment above (FIG. 2) and a function as the incorrect judgment controlling part 600 which has been described in relation to the third preferred embodiment above (FIG. 3), and the incorrect judgment controlling part 700 comprises an inner product computation part 25 and threshold value judging parts 26 and 28 and a switchover judging part 27.

During a non-voice period until a speaker actually starts speaking since the speaker turns on a speak start switch (not shown) of the voice recognition system, the inner product computation part 25 calculates an inner product V^{T}A of the feature vector A which is calculated by the LPC cepstrum computation part 17 and the trained vector V of an unvoiced sound calculated in advance by the trained vector creating part 15.

The threshold value judging part 26 compares the threshold value θ′ (=0) which is determined in advance with the inner product V^{T}A which is calculated by the inner product computation part 25, and when θ′<V^{T}A is satisfied even with only one frame, creates a control signal CNT1 which is for stopping calculation of an inner product and outputs the control signal CNT1 to the inner product computation part 18.

During a non-voice period until a speaker actually starts speaking since a speaker turns on the speak start switch (not shown) of the voice recognition system, as the LPC cepstrum computation part 17 calculates the predictive residual power ε of a background sound, the threshold value judging part 28 calculates the average ε′ of the predictive residual power ε, compares the average ε with the threshold value THD′ which is determined in advance, and when ε′<THD′ holds, creates a control signal CNT2 which is for stopping calculation of an inner product and outputs the control signal CNT2 to the inner product computation part 18.

Receiving either the control signal CNT1 or the control signal CNT2 described above from the threshold value judging part 26 or 27, the switchover judging part 27 provides the first inner product computation part 18 with the control signal CNT1 or CNT2 as the control signal CNT, whereby the processing of calculating an inner product is stopped.

Hence, when the inner product V^{T}A of the trained vector V and the feature vector A which is calculated during the non-voice period satisfies θ′<V^{T}A regarding even only one frame, or when the average ε′ of the predictive residual power ε which is calculated during the non-voice period holds the relationship ε′<THD′, even if a speaker actually utters a voice after the non-voice period elapses, the inner product computation part 18 is prohibited from the processing of calculating an inner product.

A predictive residual power ε₀ which is obtained in a relatively quiet environment is used as a reference (0 dB), and a value which is 0 dB through 50 dB higher than this is set as the threshold value THD′mentioned above. The threshold value θ′ is set as θ′=0.

The fourth preferred embodiment as well which is directed to such a structure, as in the case of the second and the third preferred embodiments described above, allows to maintain a detection accuracy of detecting a voice section even in a background wherein an SN ratio is high and spectra representing background noises are accordingly high in a high frequency region, and hence, to detect a voice section in such a manner which improves a voice recognition rate.

In the structure according to this embodiment which is shown in FIG. 4, the voice section determining part 300 outputs the decision D3 which is indicative of a voice section based on the judgment result D1 made by the threshold value judging part 19 an d the judgment result D2 made by the threshold value judging part 21.

The present invention, however, is not limited only to this. The second detecting part 200 may be omitted, so that the voice section determining part 300 outputs the decision D3 which is indicative of a voice section based on the judgment result D1 made by the first detecting part 100 and the incorrect judgment controlling part 700.

The voice recognition systems described above according to the first through the fourth preferred embodiments, as the elements 8 through 12 in FIG. 1 show, use a method in which characteristics of voices are described in the form of Markov models for recognition of a voice (i.e., an HMM method).

However, the voice cutting part which is formed by the elements 100, 200, 300, 400, 500, 600 and 700 according to the respective preferred embodiments, namely, the part which is for cutting out the input voice data Svc which are to be an object from the input signal data Saf in the unit of frames is not applicable to only an HMM method but may be applied to other processing methods for voice recognition as well. For example, application to a DP matching method which uses a dynamic programming (DP) method is also possible.

As described above, with the voice recognition system according to the present invention, a voice section is determined as a point at which an inner product value of a trained vector, which is created in advance based on an unvoiced sound, and a feature vector, which represents an input signal containing actual utterance of a voice, has a value which is equal to or larger than a predetermined threshold value, or a point at which a predictive residual power of an input signal containing actual utterance of a voice, is compared with and found to be larger than a threshold value which is calculated based on a predictive residual power of a non-voice period. Hence, it is possible to appropriately detect voiced sounds and unvoiced sounds which are an object of voice recognition.

Further, when an inner product value of a feature vector of a background sound created during a non-voice period and a trained vector is equal to or larger than a predetermined value, or when a linear predictive residual power of the signal which is created during a non-voice period is equal to or smaller than a predetermined threshold value, or when both occurs, detection of a voice section based on an inner product value of a feature vector of an input signal is not conducted. Instead, a point at which a predictive residual power of the input signal containing actual utterance of a voice is equal to or larger than a predetermined threshold value is used as a voice section. Hence, it is possible to improve a detection accuracy of detecting a voice section in a background wherein an SN ratio is high and spectra representing background noises are accordingly high in a high frequency region.

1. A voice recognition system comprising:
a voice section detecting part comprising:
a trained vector creating part for creating a characteristic of a voice as a trained vector in advance; and
an inner product value judging part for calculating an inner product of the trained vector and a feature vector of an input signal containing utterance, and judging the input signal to be a voice section when the inner product value is equal to or larger than a predetermined value;
wherein the input signal during the voice section is an object of voice recognition.

2. A voice recognition system comprising:
a voice section detecting part comprising:
a trained vector creating part for creating a characteristic of a voice as a trained vector in advance;
a threshold value creating part for a threshold value to distinguish a voice from a noise based on a linear predictive residual power of an input signal created during a non-voice period;
an inner product value judging part for calculating an inner product of the trained vector and a feature vector of an input voice containing utterance of a voice, and judging the input voice to be a first voice section when the inner product value is equal to or larger than a predetermined value; and
a linear predictive residual power judging part for judging the input signal to be a second voice section when a linear predictive residual power of the input signal is larger than the threshold value created by the threshold value creating part,
wherein the input signal during the first voice section and the second voice section is an object of voice recognition.

3. The voice recognition system in accordance with claim 2, further comprising an incorrect judgment controlling part for calculating an inner product of the trained vector and a feature vector of the input signal created during the non-voice period, and stopping the judging processing of the inner product value judging part when the inner product value is equal to or larger than a predetermined value.

4. The voice recognition system in accordance with claim 2, further comprising:
a computing part for calculating a linear predictive residual power of the input signal created during the non-voice period; and
an incorrect judgment controlling part stopping the judging processing by the inner product value judging part when the linear predictive residual power calculated by the computing part is equal to or smaller than a predetermined value.

5. The voice recognition system in accordance with claim 2, further comprising:
a computing part for calculating a linear predictive residual power of the input signal created during the non-voice period; and
an incorrect judgment controlling part for calculating an inner product of the trained vector and a feature vector of the input signal created during the non-voice period, and stopping the judging processing by the inner product value judging part when the inner product value is equal to or larger than a predetermined value or when a linear predictive residual power of the input signal which is created during the non-voice period is equal to or smaller than a predetermined value.
